(19) United States
(12) Patent Application Publication
(10) Pub. No.: US 2012/0268827 A1
(43) Pub. Date: Oct. 25, 2012

(54) COMPUTER DISPLAY WITH A BUILT-IN PRIVACY FILTER

(76) Inventors: See-Hing TIANG, City of Industry, CA (US); Khairil Singgih, City of Industry, CA (US)

(21) Appl. No.: 13/368,098

(22) Filed: Feb. 7, 2012

(30) Foreign Application Priority Data
Apr. 21, 2011 (TW) 100206994

(51) Int. Cl. G02B 27/00

(52) U.S. Cl. 359/601

(57) ABSTRACT

A computer display with a built-in privacy filter has a display panel, a frame, a privacy filter, a tape and a bezel that includes a transparent panel. With the privacy filter mounted between the transparent panel of the exposed bezel and the display panel, the transparent panel protects the privacy filter from being removed or damaged. With the area of the transparent panel appear smaller than that of privacy filter, the area where the privacy filter is attached to the display panel is hidden. When the transparent panel of the bezel is a touch screen glass, the privacy filter will not have impact on the performance of the touch screen glass given the nature of the design.

### BACKGROUND OF THE INVENTION

1. Field of the Invention

The presented invention is a computer display monitor, specifically a computer display with a built-in privacy filter that is more aesthetically appealing without affecting the performance of the display.

2. Background

Privacy filter, often in the form of rectangular shape hard plastic sheet, is a common computer display accessory. It is widely used by both consumer and industries such as banking, government, and healthcare. When installed on the surface of a display, privacy filter will reduce the viewing angle of the display, preventing it from being viewed from the side, thus achieving the goal of protecting the privacy of the user.

The most common application of privacy filter is on the screen of an ATM (Auto Teller Machine). It protects the privacy of the user by only allows the user who stands directly in front of the display to see the information on the screen, and not others who stands behind or on the sides of the user.

However, conventional method of privacy filter application where it's being attached to surface of a display screen has following disadvantages:

First, because the privacy filter is often glued to the outer surface of the screen during installation, the adhesion location where the screen and the privacy filter meet will be exposed and visible to user, thus rendered the product to be less aesthetically appealing.

Secondly, since the privacy filter is exposed externally, it is prone to be damaged by act of vandalism or normal wear and tear.

Lastly, integrating a privacy filter onto the popular touch screen display the conventional way will affect the performance of the touch screen, given most touch screen technologies require direct contact between finger that performs the touch and the touch glass that receive the touch to be functional.

The presented invention will provide a solution of a built-in type privacy filter installation, where all of these mentioned disadvantages will be resolved.

### SUMMARY OF THE INVENTION

The main objective of the present invention is to provide a computer display with a built-in privacy filter that is more aesthetically appealing with enhanced safety and without affecting the performance.

The computer display with a built-in privacy filter in accordance with the present invention comprises the following: a display panel, a frame, a privacy filter, a tape and a bezel. The frame is mounted securely around the display panel. The privacy filter is installed on a surface of display panel. The tape is used around the periphery of the privacy filter to attach the filter onto the surface of the display panel or the frame. The bezel, of which has a transparent panel enclosed, is used to mount securely around the display panel (of which has frame and privacy filter installed). The size of the transparent panel is smaller than that of the privacy filter. With the privacy filter mounted in between the transparent panel and the display panel, the transparent panel will protect the privacy filter from being removed or tempered. The viewable area of the display setup will be the same as the size of the transparent panel. And with the size of the transparent panel appear to be smaller than that of the privacy filter, the area where the privacy filter and display panel are glued together will be concealed, thus eliminating the cosmetic issue. When the transparent panel is replaced with a touch screen glass, the privacy filter will not affect its functionality since the privacy filter is mounted behind the touch panel.

### BRIEF DESCRIPTION OF THE DRAWINGS

FIG. 1 is a perspective view of a computer display with a built-in privacy filter in accordance with the present invention;

FIG. 2 is an exploded perspective view of the computer display with a built-in privacy filter in FIG. 1;

FIG. 3 is a front view of the computer display with a built-in privacy filter in FIG. 1; and

FIG. 4 is an enlarged perspective view of the computer display with a built-in privacy filter in FIG. 1.

### DETAILED DESCRIPTION OF THE CONSTRUCTION

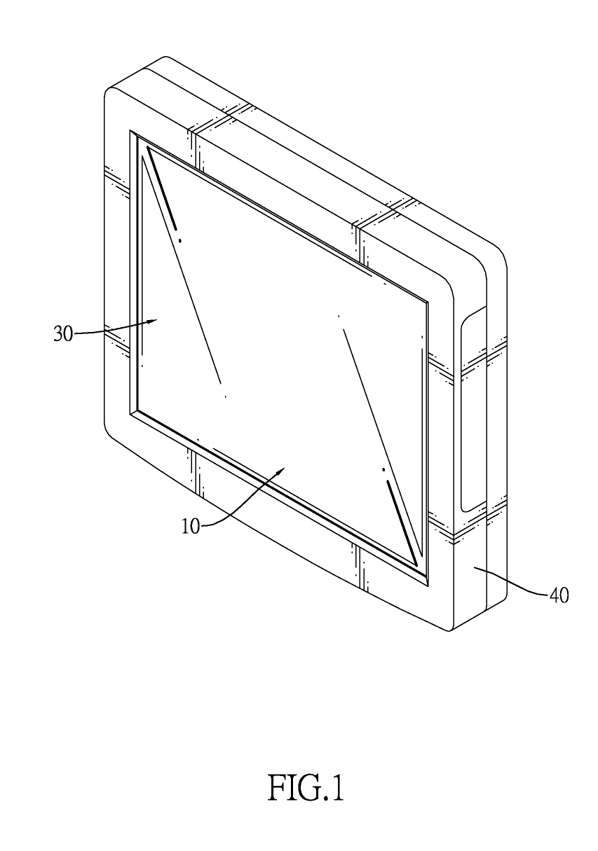

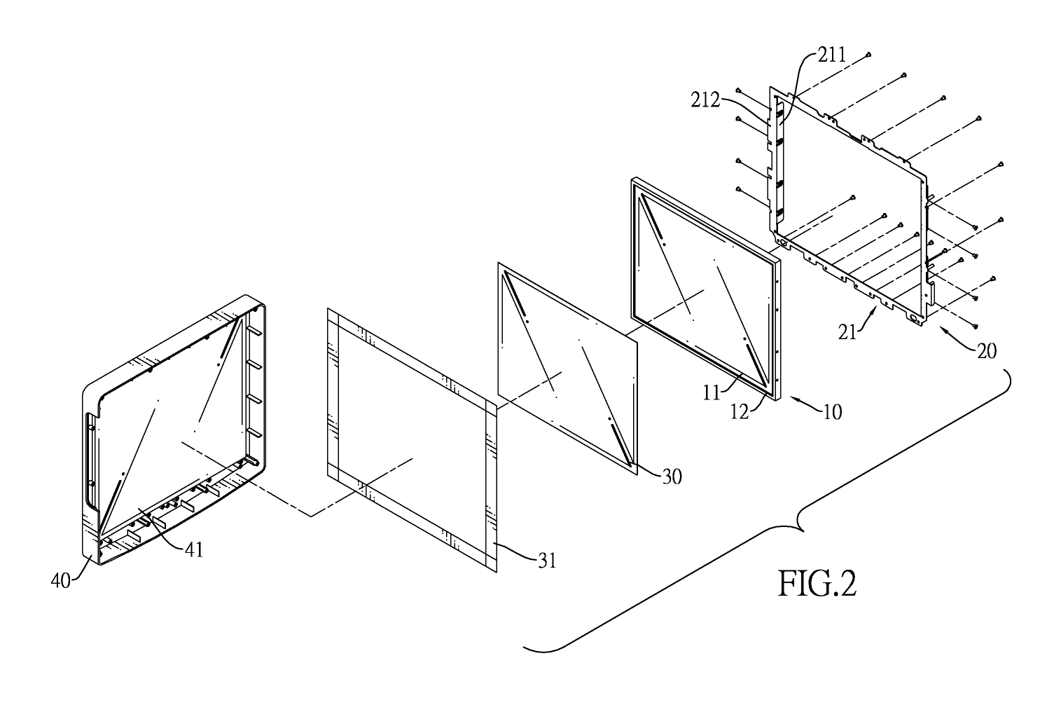

With reference to FIGS. 1 and 2, a computer display with a built-in privacy filter in accordance with the present invention comprises a display panel 10, a frame 20, a privacy filter 30, a tape 31 and a bezel 40.

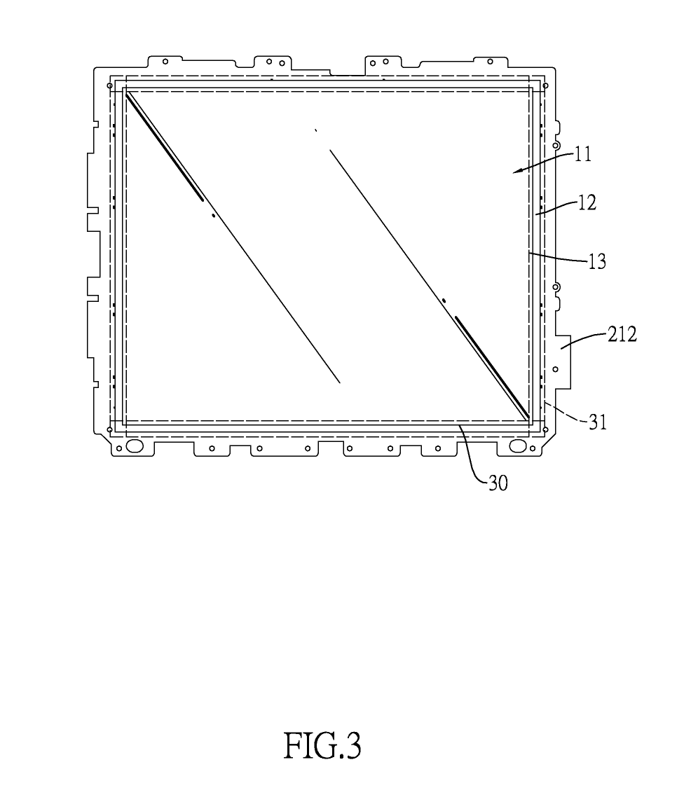

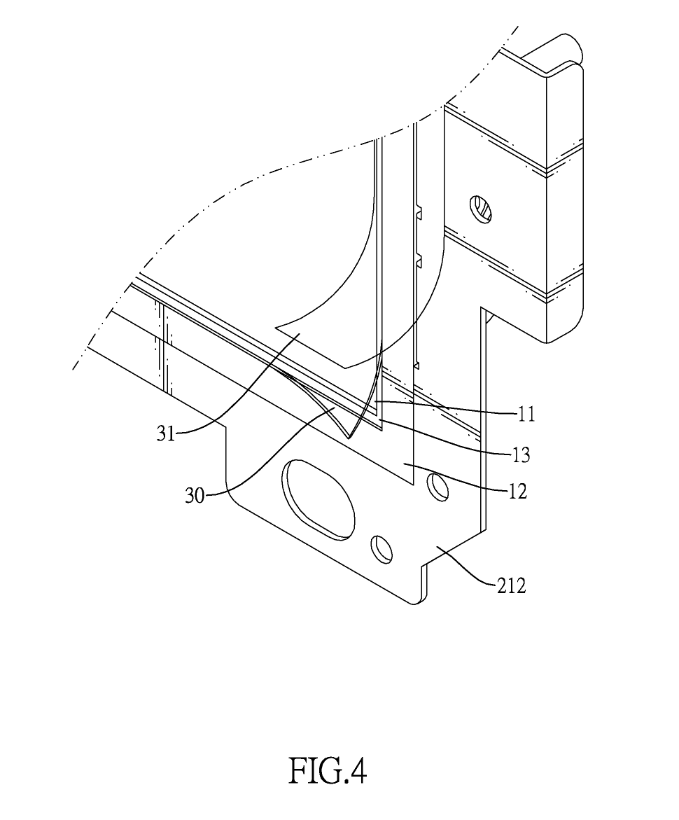

With reference to FIGS. 2 to 4, the display panel 10 has a stepped recess, a display screen 11, a flush part 13 and a surrounding part 12. The stepped recess is formed on a front surface of the display panel 10 and has a top step, a middle step and a bottom step. The display screen 11 is mounted on a center of the bottom step of the stepped recess. The flush part 13 is formed annularly around a periphery of the display screen 11 and is mounted on the middle step of the stepped recess. The surrounding part 12 is formed annularly around a periphery of the flush part 13 and is mounted on the top step of the stepped recess.

The frame 20 is mounted securely around the display panel 10 and has four rims 21. Each rim 21 is elongated, and has a display side 211 and a filter side 212. The display side 211 is perpendicular to the filter side 212. The four display sides 211 of the rims 21 respectively abut four sides of the display panel 10, and each display side 211 is attached securely to the corresponding side of the display panel 10 by screws. The four filter sides 212 of the rims 21 align with the surrounding part 12 of the display panel 10.

The privacy filter 30 is covered on the display screen 11 of the display panel 10. An area of the privacy filter 30 is larger than an area of the display screen 11 of the display panel 10. A periphery of the privacy filter 30 is flush with the flush part 13 of the display panel 10, and the privacy filter 30 is mounted in and engages with the surrounding part 12 of the display panel 10.

The tape 31 is flush with and is glued securely to the periphery of the privacy filter 30, the four filter sides 212 of the frame 20 and the surrounding part 12 of the display panel 10.

The bezel 40 is mounted securely around the frame 20, is attached securely to the four filter sides 212 of the frame 20 by screws, and has a transparent panel 41. The transparent panel 41 may be a touch panel, is mounted in a center of the bezel 40, and is mounted in front of the display screen 11 of the display panel 10. An area of the transparent panel 41 is smaller than the area of the privacy filter 30.

A fully assembled computer display with a built-in privacy filter solution is shown in FIG. 1, with the privacy filter 30 mounted in between the transparent panel 41 of the exposed bezel 40 and the display panel 10. Such invention will allow the transparent panel 41 to protect the privacy filter 30 from being removed and tampered without affecting the performance of the transparent panel 41. With the size of the transparent panel 41 appear to be smaller than that of the privacy filter 30, the area where the privacy filter 30 and display panel 10 are glued together will be concealed, thus eliminating the cosmetic issue. When the transparent panel 41 is replaced with a touch screen glass, the privacy filter 30 will not affect its functionality since the privacy filter 30 is mounted behind the touch panel.

Alternate design can be installed in such a way the transparent panel of the bezel is a transparent glass or sheet of transparent plastic.

Alternate design can be installed in such a way those tapes only covering the edge of privacy filter and the frame.

Alternate design can also be installed in such a way those tapes only cover the edge of privacy filter and display panel.

Above described designs shall not be used and considered as any type of restrictions to limit any non-technical changes to the presented invention. Such changes include, but not limited to, shape, sizes, and material type of any component parts used in the assembly of the design. Design that utilizes similar principle in constructing a computer display with built-in privacy filter as described above, even though may be constructed in different form factor, sizes, or appearance, will still be considered as falling under the same design concept as in the presented invention.

What is claimed is:

1. A computer display comprising:
a display panel having a display screen;
a frame mounted securely around the display panel;
a privacy filter covered on the display screen of the display panel;
a tape attached securely to a periphery of the privacy filter and a periphery of the display panel or the frame; and
a bezel mounted securely around the frame, and having a transparent panel mounted in front of the display screen of the display panel, wherein an area of the transparent panel is smaller than an area of the privacy filter.

2. The computer display as claimed in claim 1, wherein the area of the privacy filter is larger than an area of the display screen of the display panel.

3. The computer display as claimed in claim 2, wherein the display panel has a surrounding part formed annularly around the periphery of the display panel; and the privacy filter is mounted in and engages with the surrounding part of the display panel.

4. The computer display as claimed in claim 2, wherein the display panel has a flush part formed annularly around a periphery of the display screen of the display panel; and the periphery of the privacy filter is flush with the flush part of the display panel.

5. The computer display as claimed in claim 2, wherein the display panel has a stepped recess formed on a surface of the display panel, and having a top step, a middle step and a bottom step; a flush part formed annularly around a periphery of the display screen of the display panel and mounted on the middle step of the stepped recess; and a surrounding part formed annularly around a periphery of the flush part and mounted on the top step of the stepped recess; the display screen of the display panel is mounted on the bottom step of the stepped recess; the privacy filter is mounted in and engages with the surrounding part; and the periphery of the privacy filter is flush with the flush part.

6. The computer display as claimed in claim 1, wherein the transparent panel of the bezel is a touch screen glass or transparent glass or sheet of transparent plastic.

7. The computer display as claimed in claim 2, wherein the transparent panel of the bezel is a touch screen glass or transparent glass or sheet of transparent plastic.

8. The computer display as claimed in claim 3, wherein the transparent panel of the bezel is a touch screen glass or transparent glass or sheet of transparent plastic.

9. The computer display as claimed in claim 4, wherein the transparent panel of the bezel is a touch screen glass or transparent glass or sheet of transparent plastic.

10. The computer display as claimed in claim 5, wherein the transparent panel of the bezel is a touch screen glass or transparent glass or sheet of transparent plastic.
